(19) United States
(12) Patent Application Publication
(10) Pub. No.: US 2013/0073213 A1
(43) Pub. Date: Mar. 21, 2013

(54) Gene Expression-Based Differential Diagnostic Model for Rheumatoid Arthritis

(71) Applicants: Michael Centola, Oklahoma City, OK (US); Nicholas Knowlton, Auckland (NZ)

(72) Inventors: Michael Centola, Oklahoma City, OK (US); Nicholas Knowlton, Auckland (NZ)

(21) Appl. No.: 13/621,835

(22) Filed: Sep. 17, 2012

Related U.S. Application Data
(60) Provisional application No. 61/535,306, filed on Sep. 15, 2011.

(51) Int. Cl. G06F 19/10

(52) U.S. Cl. 702/19

(57) ABSTRACT

Biomarkers useful for differential diagnosis for rheumatoid arthritis from samples of peripheral blood mononuclear cells are provided, along with kits for measuring their expression. The invention also provides predictive models, based on the biomarkers, as well as computer systems, and software embodiments of the models for scoring and optionally classifying samples.

### RELATED APPLICATIONS

This application incorporates by reference U.S. Application No. 61/535,306 filed Sep. 15, 2011.

### GOVERNMENT FUNDING

This invention was made with government support under 2 P20 RR016478, P20 RR020143, and 5 P20 RR026688 awarded by the National Institutes of Health. The government has certain rights in the invention.

### FIELD

The present teachings are generally directed to biomarkers that provide a differential diagnostic for rheumatoid arthritis (RA) as compared to other inflammatory and/or autoimmune disease.

### BACKGROUND

RA is an example of an inflammatory disease, and is a chronic, systemic autoimmune disorder. It is one of the most common systemic autoimmune diseases worldwide. In RA, the immune system of the subject mounts an immune response to the subject's own joints as well as other organs, including the lung, blood vessels and pericardium, leading to inflammation of the joints (arthritis), widespread endothelial inflammation, and, as the disease progresses, joint structural damage (SD) due to joint space narrowing and erosion of joint tissue. This joint damage is largely irreversible, and cumulatively results in joint destruction, loss of joint function and subject disability.

Due to the symptomatic overlap between RA and other conditions, diagnosis can be challenging (Klippel J H, ed. Primer on the Rheumatic Diseases. 11 ed. Atlanta, Ga.: William Otto Group; 1997). RA can be indistinguishable clinically from self-limited arthritis, osteoarthritis (OA), or other autoimmune rheumatic (e.g. systemic lupus erythematosus (SLE), Sjögren's Syndrome, fibromyalgia) and non-rheumatic diseases (e.g. Hepatitis C Viral infection) based on the common overlapping symptoms of tenderness and inflammation in the joints. Various RA classification criteria have been defined by rheumatologic societies to identify discreet sets of signs and symptoms that can help guide diagnosis. However, classification criteria are not diagnostic; in fact, the various classification criteria were designed to best address issues thought to be most relevant for definitive RA. No specific set of signs and symptoms is pathognomonic.

Current tests include those for rheumatoid factor (RF) and antibody reactivity to cyclic citrullinated peptides (CCP). However, RF has limited sensitivity (Bas S, et al. Ann Rheum Dis 2002; 61:505-10 and Shmerling R H, et al. Arch Intern Med 1992; 152:2417-20) and extremely poor specificity (Saraux A, et. al Arthritis Rheum 2002; 47:155-65 and Shmerling R H, et al. Am J Med 1991; 91:528-34) due to the fact that RF is commonly detected in other rheumatic diseases, including up to 35% of patients with SLE, 95% of Sjögren's Syndrome (SS) patients, and even 15% of unaffected individuals (Saraux A, et. al Arthritis Rheum 2002; 47:155-65; Shmerling R H. South Med J 2005; 98:704-11; quiz 12-3, 28; and Griesmacher A, et al. Clin Chem Lab Med 2001; 39:189-208). While the specificity of CCP for RA diagnosis is higher than RF (Vander Cruyssen B et al. Ann Rheum Dis 2005; 64:1145-9; Vander Cruyssen B, et al. Autoimmun Rev 2005; 4:468-74; and Mathsson L, et al. Arthritis Rheum 2008; 58:36-45) sensitivity is approximately 60% (Vander Cruyssen B et al. Ann Rheum Dis 2005; 64:1145-9; Vander Cruyssen B, et al. Autoimmun Rev 2005; 4:468-74; and Egerer K, et al. Dtsch Arztebl Int 2009; 106:159-63).

What is needed is to identify gene expression-based markers in peripheral blood mononuclear cells (PBMC) that will distinguish RA from other symptomatically overlapping conditions.

### SUMMARY

In a first aspect, a method for scoring a sample is provided, said method comprising: receiving a dataset associated with a peripheral blood mononuclear cell sample from a subject comprising quantitative data for at least 10 of the biomarkers listed in Table 2; and determining, a score using the quantitative data wherein said score is predictive of diagnosis of rheumatoid arthritis.

In one embodiment, the dataset is obtained by a method comprising: obtaining said first sample from said first subject, wherein said sample comprises a plurality of analytes; contacting said first sample with a reagent; generating a plurality of complexes between said reagent and said plurality of analytes; and detecting said plurality of complexes to obtain said first dataset associated with said first sample, wherein said first dataset comprises quantitative data for said biomarkers.

In one embodiment, the dataset comprises quantitative data for MAP2K2, CSNK1G2, LOC654194, LOC346950 and DEFA1.

In one embodiment, determining a score comprises using an interpretation function based on a predictive model.

In additional aspects, systems implementing the method and computer-readable storage media comprising the method are provided.

### BRIEF DESCRIPTION OF THE DRAWINGS

FIG. 1 illustrates accuracy of the model as a function of number of markers used.

FIG. 2 illustrates a computer according to one embodiment.

### DETAILED DESCRIPTION

These and other features of the present teachings will become more apparent from the description herein. While the present teachings are described in conjunction with various embodiments, it is not intended that the present teachings be limited to such embodiments. On the contrary, the present teachings encompass various alternatives, modifications, and equivalents, as will be appreciated by those of skill in the art.

The present teachings relate generally to the identification of biomarkers in PBMC associated with subjects having inflammatory and/or autoimmune diseases, such as for example RA, and that are useful in identifying RA and differentiating it from diseases that have similar symptoms.

All publications recited herein are hereby incorporated by reference in their entirety for all purposes.

Most of the words used in this specification have the meaning that would be attributed to those words by one skilled in the art. Words specifically defined in the specification have the meaning provided in the context of the present teachings as a whole, and as are typically understood by those skilled in the art. In the event that a conflict arises between an art-understood definition of a word or phrase and a definition of the word or phrase as specifically taught in this specification, the specification shall control. It must be noted that, as used in the specification and the appended claims, the singular forms “a,” “an,” and “the” include plural referents unless the context clearly dictates otherwise.

“Accuracy” refers to the degree that a measured or calculated value conforms to its actual value. “Accuracy” in clinical testing relates to the proportion of actual outcomes (true positives or true negatives, wherein a subject is correctly classified as having disease or as healthy/normal, respectively) versus incorrectly classified outcomes (false positives or false negatives, wherein a subject is incorrectly classified as having disease or as healthy/normal, respectively). Other and/or equivalent terms for “accuracy” can include, for example, “sensitivity,” “specificity,” “positive predictive value (PPV),” “the AUC,” “negative predictive value (NPV),” “likelihood,” and “odds ratio.” “Analytical accuracy,” in the context of the present teachings, refers to the repeatability and predictability of the measurement process. Analytical accuracy can be summarized in such measurements as, e.g., coefficients of variation (CV), and tests of concordance and calibration of the same samples or controls at different times or with different assessors, users, equipment, and/or reagents. See, e.g., R. Vasan, Circulation 2006, 113(19):2335-2362 for a summary of considerations in evaluating new biomarkers.

The term “algorithm” encompasses any formula, model, mathematical equation, algorithmic, analytical or programmed process, or statistical technique or classification analysis that takes one or more inputs or parameters, whether continuous or categorical, and calculates an output value, index, index value or score. Examples of algorithms include but are not limited to ratios, sums, regression operators such as exponents or coefficients, biomarker value transformations and normalizations (including, without limitation, normalization schemes that are based on clinical parameters such as age, gender, ethnicity, etc.), rules and guidelines, statistical classification models, and neural networks trained on populations. Also of use in the context of biomarkers are linear and non-linear equations and statistical classification analyses to determine the relationship between (a) levels of biomarkers detected in a subject sample and (b) the level of the respective subject's disease progression.

The term “antibody” refers to any immunoglobulin-like molecule that reversibly binds to another with the required selectivity. Thus, the term includes any such molecule that is capable of selectively binding to a biomarker of the present teachings. The term includes an immunoglobulin molecule capable of binding an epitope present on an antigen. The term is intended to encompass not only intact immunoglobulin molecules, such as monoclonal and polyclonal antibodies, but also antibody isotypes, recombinant antibodies, bi-specific antibodies, humanized antibodies, chimeric antibodies, anti-idiopathic (anti-ID) antibodies, single-chain antibodies, Fab fragments, F(ab′) fragments, fusion protein antibody fragments, immunoglobulin fragments, Fᵥ fragments, single chain Fᵥ fragments, and chimeras comprising an immunoglobulin sequence and any modifications of the foregoing that comprise an antigen recognition site of the required selectivity.

“Biomarker,” “biomarkers,” “marker” or “markers” in the context of the present teachings encompasses, without limitation, cytokines, chemokines, growth factors, proteins, peptides, nucleic acids, oligonucleotides, and metabolites, together with their related metabolites, mutations, isoforms, variants, polymorphisms, modifications, fragments, subunits, degradation products, elements, and other analytes or sample-derived measures. Biomarkers can also include mutated proteins, mutated nucleic acids, variations in copy numbers and/or transcript variants. Biomarkers also encompass non-blood borne factors and non-analyte physiological markers of health status, and/or other factors or markers not measured from samples (e.g., biological samples such as bodily fluids), such as clinical parameters and traditional factors for clinical assessments. Biomarkers can also include any indices that are calculated and/or created mathematically. Biomarkers can also include combinations of any one or more of the foregoing measurements, including temporal trends and differences.

The term “cytokine” in the present teachings refers to any substance secreted by specific cells of the immune system that carries signals locally between cells and thus has an effect on other cells. The term “cytokines” encompasses “growth factors.” “Chemokines” are also cytokines. They are a subset of cytokines that are able to induce chemotaxis in cells; thus, they are also known as “chemotactic cytokines.”

A “dataset” is a set of numerical values resulting from evaluation of a sample (or population of samples) under a desired condition. The values of the dataset can be obtained, for example, by experimentally obtaining measures from a sample and constructing a dataset from these measurements; or alternatively, by obtaining a dataset from a service provider such as a laboratory, or from a database or a server on which the dataset has been stored.

“Interpretation function,” as used herein, means the transformation of a set of observed data into a meaningful determination of particular interest; e.g., an interpretation function may be a predictive model that is created by utilizing one or more statistical algorithms to transform a dataset of observed biomarker data into a meaningful determination of disease activity or the disease state of a subject.

“Performance” in the context of the present teachings relates to the quality and overall usefulness of, e.g., a model, algorithm, or diagnostic or prognostic test. Factors to be considered in model or test performance include, but are not limited to, the clinical and analytical accuracy of the test, use characteristics such as stability of reagents and various components, ease of use of the model or test, health or economic value, and relative costs of various reagents and components of the test.

A “quantitative dataset,” as used in the present teachings, refers to the data derived from, e.g., detection and composite measurements of a plurality of biomarkers (i.e., two or more) in a subject sample. The quantitative dataset can be used in the identification, monitoring and treatment of disease states, and in characterizing the biological condition of a subject. It is possible that different biomarkers will be detected depending on the disease state or physiological condition of interest.

A “predictive model,” which term may be used synonymously herein with “multivariate model” or simply a “model,” is a mathematical construct developed using a statistical algorithm or algorithms for classifying sets of data. The term “predicting” refers to generating a value for a datapoint without actually performing the clinical diagnostic procedures normally or otherwise required to produce that datapoint; “predicting” as used in this modeling context should not be understood solely to refer to the power of a model to predict a particular outcome. Predictive models can provide an interpretation function; e.g., a predictive model can be created by utilizing one or more statistical algorithms or methods to transform a dataset of observed data into a meaningful determination of disease diagnosis.

A “score” is a value or set of values selected so as to provide a quantitative measure of a variable or characteristic of a subject's condition, and/or to discriminate, differentiate or otherwise characterize a subject's condition. The value(s) comprising the score can be based on, for example, a measured amount of one or more sample constituents obtained from the subject. The score can be based upon or derived from an interpretation function; e.g., an interpretation function derived from a particular predictive model using any of various statistical algorithms known in the art.

“Statistically significant” in the context of the present teachings means an observed alteration is greater than what would be expected to occur by chance alone (e.g., a “false positive”). Statistical significance can be determined by any of various methods well-known in the art. An example of a commonly used measure of statistical significance is the p-value. The p-value represents the probability of obtaining a given result equivalent to a particular datapoint, where the datapoint is the result of random chance alone. A result is often considered highly significant (not random chance) at a p-value less than or equal to 0.05.

A “subject” in the context of the present teachings is generally a mammal. The subject can be a patient. The term “mammal” as used herein includes but is not limited to a human, non-human primate, dog, cat, mouse, rat, cow, horse, and pig. Mammals other than humans can be advantageously used as subjects that represent animal models of inflammation. A subject can be male or female. A subject can be one who has been previously diagnosed or identified as having an inflammatory disease. A subject can be one who has already undergone, or is undergoing, a therapeutic intervention for an inflammatory disease. A subject can also be one who has not been previously diagnosed as having an inflammatory disease; e.g., a subject can be one who exhibits one or more symptoms or risk factors for an inflammatory condition, or a subject who does not exhibit symptoms or risk factors for an inflammatory condition, or a subject who is asymptomatic for inflammatory disease.

The disclosed analysis provides for not just identification of patients with RA as compared to other autoimmune disorders but also identifying osteoarthritis and systemic lupus erythematosis.

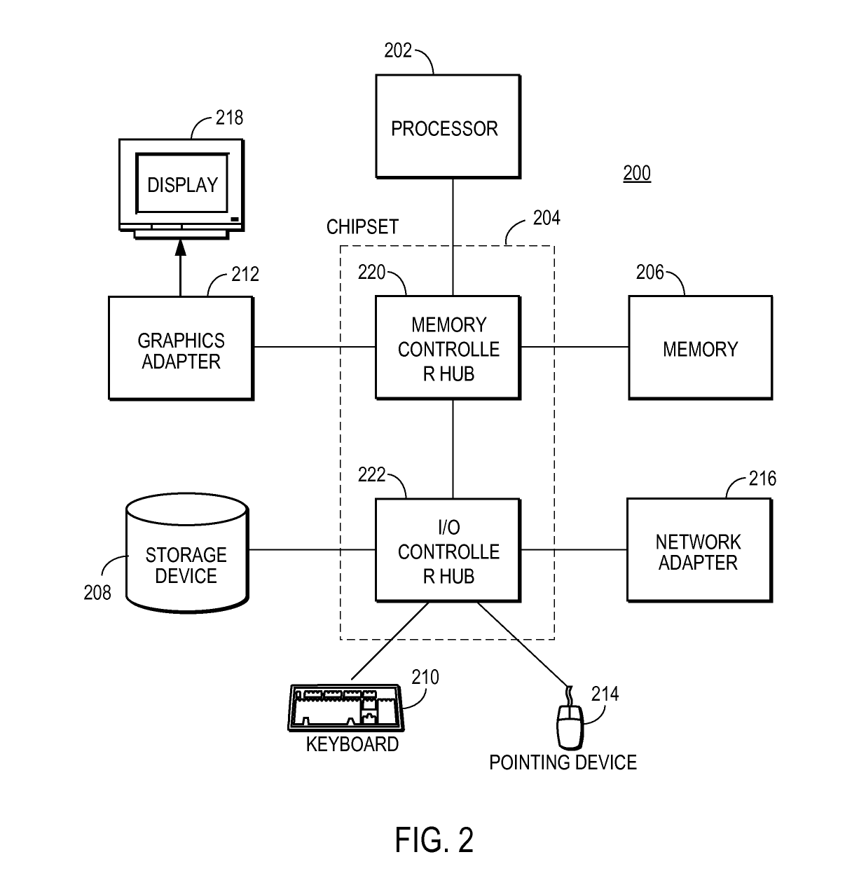

Also provided are computer-implemented methods and systems for differential diagnosis of RA. The computers on which the methods are implemented may include a single processor or may be architectures employing multiple processor designs for increased computing capability. FIG. 2 is a high-level block diagram of a computer (200). Illustrated are at least one processor (202) coupled to a chipset (204). Also coupled to the chipset (204) are a memory (206), a storage device (208), a keyboard (210), a graphics adapter (212), a pointing device (214), and a network adapter (216). A display (218) is coupled to the graphics adapter (212). In one embodiment, the functionality of the chipset (204) is provided by a memory controller hub 220) and an I/O controller hub (222). In another embodiment, the memory (206) is coupled directly to the processor (202) instead of the chipset (204). The storage device 208 is any non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. The memory (206) holds instructions and data used by the processor (202). The pointing device (214) may be a mouse, track ball, or other type of pointing device, and is used in combination with the keyboard (210) to input data into the computer system (200). The graphics adapter (212) displays images and other information on the display (218). The network adapter (216) couples the computer system (200) to a local or wide area network.

### Differential Diagnosis of Rheumatoid Arthritis

In one embodiment, a score for diagnosis of RA is determined using a dataset comprising expression levels of 8, 9, 10, 11, 12, 13, 14, 15, 16, 17, 18, 19, 20, 21, 22, 23, 24, 25, 26 or 27 of the biomarkers in Table 2.

In one embodiment, a score for diagnosis of RA is determined using a dataset comprising expression levels of at least 10 of the biomarkers in Table 2

In one embodiment, a score for diagnosis of RA is determined using a dataset comprising expression levels of 1, 2, 3, 4 or 5 of MAP2K2, CSNK1G2, LOC654194, LOC346950 and DEFA1.

### Development of Model

The score for differential diagnosis is determined through an interpretation function. The interpretation function is based on a predictive model. Established statistical algorithms and methods well-known in the art, useful as models or useful in designing predictive models, can include but are not limited to: analysis of variants (ANOVA); Bayesian networks; boosting and Ada-boosting; bootstrap aggregating (or bagging) algorithms; decision trees classification techniques, such as Classification and Regression Trees (CART), boosted CART, Random Forest (RF), Recursive Partitioning Trees (RPART), and others; Curds and Whey (CW); Curds and Whey-Lasso; dimension reduction methods, such as principal component analysis (PCA) and factor rotation or factor analysis; discriminant analysis, including Linear Discriminant Analysis (LDA), Eigengene Linear Discriminant Analysis (ELDA), and quadratic discriminant analysis; Discriminant Function Analysis (DFA); factor rotation or factor analysis; genetic algorithms; Hidden Markov Models; kernel based machine algorithms such as kernel density estimation, kernel partial least squares algorithms, kernel matching pursuit algorithms, kernel Fisher's discriminate analysis algorithms, and kernel principal components analysis algorithms; linear regression and generalized linear models, including or utilizing Forward Linear Stepwise Regression, Lasso (or LASSO) shrinkage and selection method, and Elastic Net regularization and selection method; glmnet (Lasso and Elastic Net-regularized generalized linear model); Logistic Regression (LogReg); meta-learner algorithms; nearest neighbor methods for classification or regression, e.g. Kth-nearest neighbor (KNN); non-linear regression or classification algorithms; neural networks; partial least square; rules based classifiers; shrunken centroids (SC); sliced inverse regression; Standard for the Exchange of Product model data, Application Interpreted Constructs (StepAIC); super principal component (SPC) regression; and, Support Vector Machines (SVM) and Recursive Support Vector Machines (RSVM), among others. Additionally, clustering algorithms as are known in the art can be useful in determining subject sub-groups.

Logistic Regression is the traditional predictive modeling method of choice for dichotomous response variables; e.g., treatment 1 versus treatment 2. It can be used to model both linear and non-linear aspects of the data variables and provides easily interpretable odds ratios.

Discriminant Function Analysis (DFA) uses a set of analytes as variables (roots) to discriminate between two or more naturally occurring groups. DFA is used to test analytes that are significantly different between groups. A forward step-wise DFA can be used to select a set of analytes that maximally discriminate among the groups studied. Specifically, at each step all variables can be reviewed to determine which will maximally discriminate among groups. This information is then included in a discriminative function, denoted a root, which is an equation consisting of linear combinations of analyte concentrations for the prediction of group membership. The discriminatory potential of the final equation can be observed as a line plot of the root values obtained for each group. This approach identifies groups of analytes whose changes in concentration levels can be used to delineate profiles, diagnose and assess therapeutic efficacy. The DFA model can also create an arbitrary score by which new subjects can be classified as either “healthy” or “diseased.” To facilitate the use of this score for the medical community the score can be rescaled so a value of 0 indicates a healthy individual and scores greater than 0 indicate increasing disease activity.

Classification and regression trees (CART) perform logical splits (if/then) of data to create a decision tree. All observations that fall in a given node are classified according to the most common outcome in that node. CART results are easily interpretable—one follows a series of if/then tree branches until a classification results.

Support vector machines (SVM) classify objects into two or more classes. Examples of classes include sets of treatment alternatives, sets of diagnostic alternatives, or sets of prognostic alternatives. Each object is assigned to a class based on its similarity to (or distance from) objects in the training data set in which the correct class assignment of each object is known. The measure of similarity of a new object to the known objects is determined using support vectors, which define a region in a potentially high dimensional space (>R6).

The process of bootstrap aggregating, or “bagging,” is computationally simple. In the first step, a given dataset is randomly resampled a specified number of times (e.g., thousands), effectively providing that number of new datasets, which are referred to as “bootstrapped resamples” of data, each of which can then be used to build a model. Then, in the example of classification models, the class of every new observation is predicted by the number of classification models created in the first step. The final class decision is based upon a “majority vote” of the classification models; i.e., a final classification call is determined by counting the number of times a new observation is classified into a given group, and taking the majority classification (33%+ for a three-class system). In the example of logistical regression models, if a logistical regression is bagged 1000 times, there will be 1000 logistical models, and each will provide the probability of a sample belonging to class 1 or 2.

Curds and Whey (CW) using ordinary least squares (OLS) is another predictive modeling method. See L. Breiman and J H Friedman, J. Royal. Stat. Soc. B 1997, 59(1):3-54. This method takes advantage of the correlations between response variables to improve predictive accuracy, compared with the usual procedure of performing an individual regression of each response variable on the common set of predictor variables X. In CW, Y=XB*S, where Y=(yₖⱼ) with k for the k^{th} patient and j for j^{th} response (j=1 for TJC, j=2 for SJC, etc.), B is obtained using OLS, and S is the shrinkage matrix computed from the canonical coordinate system. Another method is Curds and Whey and Lasso in combination (CW-Lasso). Instead of using OLS to obtain B, as in CW, here Lasso is used, and parameters are adjusted accordingly for the Lasso approach.

Many of these techniques are useful either combined with a biomarker selection technique (such as, for example, forward selection, backwards selection, or stepwise selection), or for complete enumeration of all potential panels of a given size, or genetic algorithms, or they can themselves include biomarker selection methodologies in their own techniques. These techniques can be coupled with information criteria, such as Akaike's Information Criterion (AIC), Bayes Information Criterion (BIC), or cross-validation, to quantify the tradeoff between the inclusion of additional biomarkers and model improvement, and to minimize overfit. The resulting predictive models can be validated in other studies, or cross-validated in the study they were originally trained in, using such techniques as, for example, Leave-One-Out (LOO) and 10-Fold cross-validation (10-Fold CV).

### Measurement of Biomarkers

The quantity of one or more biomarkers of the present teachings can be indicated as a value. The value can be one or more numerical values resulting from the evaluation of a sample, and can be derived, e.g., by measuring level(s) of the biomarker(s) in a sample by an assay performed in a laboratory, or from dataset obtained from a provider such as a laboratory, or from a dataset stored on a server. Biomarker levels can be measured using any of several techniques known in the art. The present teachings encompass such techniques, and further include all subject fasting and/or temporal-based sampling procedures for measuring biomarkers.

The actual measurement of levels of the biomarkers can be determined at the protein or nucleic acid level using any method known in the art. “Protein” detection comprises detection of full-length proteins, mature proteins, pre-proteins, polypeptides, isoforms, mutations, variants, post-translationally modified proteins and variants thereof, and can be detected in any suitable manner. Levels of biomarkers can be determined at the protein level, e.g., by measuring the serum levels of peptides encoded by the gene products described herein, or by measuring the enzymatic activities of these protein biomarkers. Such methods are well-known in the art and include, e.g., immunoassays based on antibodies to proteins encoded by the genes, aptamers or molecular imprints. Any biological material can be used for the detection/quantification of the protein or its activity. Alternatively, a suitable method can be selected to determine the activity of proteins encoded by the biomarker genes according to the activity of each protein analyzed. For biomarker proteins, polypeptides, isoforms, mutations, and variants thereof known to have enzymatic activity, the activities can be determined in vitro using enzyme assays known in the art. Such assays include, without limitation, protease assays, kinase assays, phosphatase assays, reductase assays, among many others. Modulation of the kinetics of enzyme activities can be determined by measuring the rate constant KM using known algorithms, such as the Hill plot, Michaelis-Menten equation, linear regression plots such as Lineweaver-Burk analysis, and Scatchard plot.

Using sequence information provided by the public database entries for the biomarker, expression of the biomarker can be detected and measured using techniques well-known to those of skill in the art. For example, nucleic acid sequences in the sequence databases that correspond to nucleic acids of biomarkers can be used to construct primers and probes for detecting and/or measuring biomarker nucleic acids. These probes can be used in, e.g., Northern or Southern blot hybridization analyses, ribonuclease protection assays, and/or methods that quantitatively amplify specific nucleic acid sequences. As another example, sequences from sequence databases can be used to construct primers for specifically amplifying biomarker sequences in, e.g., amplification-based detection and quantitation methods such as reverse-transcription based polymerase chain reaction (RT-PCR) and PCR. When alterations in gene expression are associated with gene amplification, nucleotide deletions, polymorphisms, post-translational modifications and/or mutations, sequence comparisons in test and reference populations can be made by comparing relative amounts of the examined DNA sequences in the test and reference populations.

As an example, Northern hybridization analysis using probes which specifically recognize one or more of these sequences can be used to determine gene expression. Alternatively, expression can be measured using RT-PCR; e.g., polynucleotide primers specific for the differentially expressed biomarker mRNA sequences reverse-transcribe the mRNA into DNA, which is then amplified in PCR and can be visualized and quantified. Biomarker RNA can also be quantified using, for example, other target amplification methods, such as TMA, SDA, and NASBA, or signal amplification methods (e.g., bDNA), and the like. Ribonuclease protection assays can also be used, using probes that specifically recognize one or more biomarker mRNA sequences, to determine gene expression.

Alternatively, biomarker protein and nucleic acid metabolites can be measured. The term “metabolite” includes any chemical or biochemical product of a metabolic process, such as any compound produced by the processing, cleavage or consumption of a biological molecule (e.g., a protein, nucleic acid, carbohydrate, or lipid). Metabolites can be detected in a variety of ways known to one of skill in the art, including the refractive index spectroscopy (RI), ultra-violet spectroscopy (UV), fluorescence analysis, radiochemical analysis, near-infrared spectroscopy (near-IR), nuclear magnetic resonance spectroscopy (NMR), light scattering analysis (LS), mass spectrometry, pyrolysis mass spectrometry, nephelometry, dispersive Raman spectroscopy, gas chromatography combined with mass spectrometry, liquid chromatography combined with mass spectrometry, matrix-assisted laser desorption ionization-time of flight (MALDI-TOF) combined with mass spectrometry, ion spray spectroscopy combined with mass spectrometry, capillary electrophoresis, NMR and IR detection. See WO 04/056456 and WO 04/088309, each of which is hereby incorporated by reference in its entirety. In this regard, other biomarker analytes can be measured using the above-mentioned detection methods, or other methods known to the skilled artisan. For example, circulating calcium ions (Ca²⁺) can be detected in a sample using fluorescent dyes such as the Fluo series, Fura-2A, Rhod-2, among others. Other biomarker metabolites can be similarly detected using reagents that are specifically designed or tailored to detect such metabolites.

In some embodiments, a biomarker is detected by contacting a subject sample with reagents, generating complexes of reagent and analyte, and detecting the complexes. Examples of “reagents” include but are not limited to nucleic acid primers and antibodies.

In some embodiments of the present teachings an antibody binding assay is used to detect a biomarker; e.g., a sample from the subject is contacted with an antibody reagent that binds the biomarker analyte, a reaction product (or complex) comprising the antibody reagent and analyte is generated, and the presence (or absence) or amount of the complex is determined. The antibody reagent useful in detecting biomarker analytes can be monoclonal, polyclonal, chimeric, recombinant, or a fragment of the foregoing, as discussed in detail above, and the step of detecting the reaction product can be carried out with any suitable immunoassay.

Immunoassays carried out in accordance with the present teachings can be homogeneous assays or heterogeneous assays. In a homogeneous assay the immunological reaction can involve the specific antibody (e.g., anti-biomarker protein antibody), a labeled analyte, and the sample of interest. The label produces a signal, and the signal arising from the label becomes modified, directly or indirectly, upon binding of the labeled analyte to the antibody. Both the immunological reaction of binding, and detection of the extent of binding, can be carried out in a homogeneous solution. Immunochemical labels which can be employed include but are not limited to free radicals, radioisotopes, fluorescent dyes, enzymes, bacteriophages, and coenzymes. Immunoassays include competition assays.

In a heterogeneous assay approach, the reagents can be the sample of interest, an antibody, and a reagent for producing a detectable signal. Samples as described above can be used. The antibody can be immobilized on a support, such as a bead (such as protein A and protein G agarose beads), plate or slide, and contacted with the sample suspected of containing the biomarker in liquid phase. The support is separated from the liquid phase, and either the support phase or the liquid phase is examined using methods known in the art for detecting signal. The signal is related to the presence of the analyte in the sample. Methods for producing a detectable signal include but are not limited to the use of radioactive labels, fluorescent labels, or enzyme labels. For example, if the antigen to be detected contains a second binding site, an antibody which binds to that site can be conjugated to a detectable (signal-generating) group and added to the liquid phase reaction solution before the separation step. The presence of the detectable group on the solid support indicates the presence of the biomarker in the test sample. Examples of suitable immunoassays include but are not limited to oligonucleotides, immunoblotting, immunoprecipitation, immunofluorescence methods, chemiluminescence methods, electrochemiluminescence (ECL), and/or enzyme-linked immunoassays (ELISA).

Those skilled in the art will be familiar with numerous specific immunoassay formats and variations thereof which can be useful for carrying out the method disclosed herein. See, e.g., E. Maggio, Enzyme-Immunoassay(1980), CRC Press, Inc., Boca Raton, Fla. See also U.S. Pat. No. 4,727,022 to C. Skold et al., titled “Novel Methods for Modulating Ligand-Receptor Interactions and their Application”; U.S. Pat. No. 4,659,678 to G C Forrest et al., titled “Immunoassay of Antigens”; U.S. Pat. No. 4,376,110 to G S David et al., titled “Immunometric Assays Using Monoclonal Antibodies”; U.S. Pat. No. 4,275,149 to D. Litman et al., titled “Macromolecular Environment Control in Specific Receptor Assays”; U.S. Pat. No. 4,233,402 to E. Maggio et al., titled “Reagents and Method Employing Channeling”; and, U.S. Pat. No. 4,230,797 to R. Boguslaski et al., titled “Heterogenous Specific Binding Assay Employing a Coenzyme as Label.”

Antibodies can be conjugated to a solid support suitable for a diagnostic assay (e.g., beads such as protein A or protein G agarose, microspheres, plates, slides or wells formed from materials such as latex or polystyrene) in accordance with known techniques, such as passive binding. Antibodies as described herein can likewise be conjugated to detectable labels or groups such as radiolabels (e.g., 35S, 125I, 131I), enzyme labels (e.g., horseradish peroxidase, alkaline phosphatase), and fluorescent labels (e.g., fluorescein, Alexa, green fluorescent protein, rhodamine) in accordance with known techniques.

Antibodies may also be useful for detecting post-translational modifications of biomarkers. Examples of post-translational modifications include, but are not limited to tyrosine phosphorylation, threonine phosphorylation, serine phosphorylation, citrullination and glycosylation (e.g., O-GlcNAc). Such antibodies specifically detect the phosphorylated amino acids in a protein or proteins of interest, and can be used in the immunoblotting, immunofluorescence, and ELISA assays described herein. These antibodies are well-known to those skilled in the art, and commercially available. Post-translational modifications can also be determined using metastable ions in reflector matrix-assisted laser desorption ionization-time of flight mass spectrometry (MALDI-TOF). See U. Wirth et al., Proteomics 2002, 2(10):1445-1451.

### Kits

Other embodiments of the present teachings comprise biomarker detection reagents packaged together in the form of a kit for conducting any of the assays of the present teachings. In certain embodiments, the kits comprise oligonucleotides that specifically identify one or more biomarker nucleic acids based on homology and/or complementarity with biomarker nucleic acids. The oligonucleotide sequences may correspond to fragments of the biomarker nucleic acids. For example, the oligonucleotides can be more than 200, 200, 150, 100, 50, 25, 10, or fewer than 10 nucleotides in length. In other embodiments, the kits comprise antibodies to proteins encoded by the biomarker nucleic acids. The kits of the present teachings can also comprise aptamers. The kit can contain in separate containers a nucleic acid or antibody (the antibody either bound to a solid matrix, or packaged separately with reagents for binding to a matrix), control formulations (positive and/or negative), and/or a detectable label, such as but not limited to fluorescein, green fluorescent protein, rhodamine, cyanine dyes, Alexa dyes, luciferase, and radiolabels, among others. Instructions for carrying out the assay, including, optionally, instructions for generating a score, can be included in the kit; e.g., written, tape, VCR, or CD-ROM. The assay can for example be in the form of a Northern hybridization or a sandwich ELISA as known in the art.

In some embodiments of the present teachings, biomarker detection reagents can be immobilized on a solid matrix, such as a porous strip, to form at least one biomarker detection site. In some embodiments, the measurement or detection region of the porous strip can include a plurality of sites containing a nucleic acid. In some embodiments, the test strip can also contain sites for negative and/or positive controls. Alternatively, control sites can be located on a separate strip from the test strip. Optionally, the different detection sites can contain different amounts of immobilized nucleic acids, e.g., a higher amount in the first detection site and lesser amounts in subsequent sites. Upon the addition of test sample, the number of sites displaying a detectable signal provides a quantitative indication of the amount of biomarker present in the sample. The detection sites can be configured in any suitably detectable shape and can be, e.g., in the shape of a bar or dot spanning the width of a test strip.

In other embodiments of the present teachings, the kit can contain a nucleic acid substrate array comprising one or more nucleic acid sequences. The nucleic acids on the array specifically identify one or more nucleic acid sequences represented in Table 2. In another embodiment, nucleic acids on the array specifically identify MAP2K2, CSNK1G2, LOC654194, LOC346950 and DEFA1. In various embodiments, the expression of one or more of the sequences of interest can be identified by virtue of binding to the array. In some embodiments the substrate array can be on a solid substrate, such as what is known as a “chip.” See, e.g., U.S. Pat. No. 5,744,305. In some embodiments the substrate array can be a solution array; e.g., xMAP (Luminex, Austin, Tex.), Cyvera (Illumina, San Diego, Calif.), RayBio Antibody Arrays (RayBiotech, Inc., Norcross, Ga.), CellCard (Vitra Bioscience, Mountain View, Calif.) and Quantum Dots' Mosaic (Invitrogen, Carlsbad, Calif.).

### Example

### BOSSANOVA™ Analysis to Determine Predictive Genes

Introduction

Gene expression profiling using Illumina WG-6 Expression BeadChips was performed on peripheral blood mononuclear cells (PBMC) from 76 subjects with RA, 64 subjects with osteoarthritis, 65 subjects with systemic lupus erythematosus, and 82 unaffected controls. Samples were randomly split 70%/30% into training and validation cohorts. 27 statistically significant genes were identified that were capable of distinguishing at least two groups. These genes were then used to create model algorithms using random forest, boosted trees, K-nearest neighbor, and Classification & Regression Trees (C&RT). With these 27 genes, a model utilizing boosted trees performed superiorly, in terms of overall accuracy, to others with an accuracy of 84% in the training cohort. Further analysis revealed that the use of 5 of those 27 genes resulted in an improved accuracy of 87%. These 5 gene expression biomarkers resulted in a robust classification algorithm that was validated with 66% accuracy in an independent cohort. RA sensitivity and specificity in the validation cohort were 57% and 87%, respectively.

Two hundred five subjects with RA, osteoarthritis (“OA”), or systemic lupus erythematosus (“SLE”) were collected at three community arthritis centers in Oklahoma. These included 76 patients with RA according to the 1987 Revised Criteria for RA by the American College of Rheumatology (Arnett F C, et al. Arthritis Rheum 1988; 31:315-24), 64 patients with OA according to OA criteria (Altman R, et al. Arthritis Rheum 1990; 33:1601-10; Altman R, et al. Arthritis Rheum 1991; 34:505-14; and Kawasaki T, et al. Ryumachi 1998; 38:2-5), and 65 patients with SLE according to the 1997 Revised Criteria for SLE (Hochberg M C. Arthritis and rheumatism 1997; 40:1725). Eighty-two unaffected controls were recruited at the Oklahoma Medical Research Foundation and Oklahoma Blood Institute. The Institutional Review Board at the Oklahoma Medical Research Foundation approved the study protocol (OMRF #00-04), and all the participants provided written informed consent. Inclusion criteria were: 1) subjects between that ages of 18-90 years of age, 2) no current signs or symptoms of severe, progressive or uncontrolled renal, hepatic, hematologic, gastrointestinal, endocrine, pulmonary, cardiac, neurologic, or cerebral disease with the exception of SLE patients who could have renal, hematologic, and neurologic symptoms, 3) no known malignancy or history of malignancy within the previous 5 years, with the exception of basal cell or squamous cell carcinoma of the skin that has been fully excised with no evidence of recurrence, 4) not being seropositive for HIV, and 5) no active substance abuse. Global exclusion criteria included steroid therapy use within the 4 weeks preceding blood collection. Exclusion criteria for controls included no cold symptoms (cough, sore throat, runny nose, and fever) within the past 2 weeks prior to blood draw, and no previous or current diagnosis with any autoimmune disease. All patients were assessed for the following: DAS 28 (Prevoo ML, et al. Arthritis Rheum 1995; 38:44-8), Health Assessment Questionnaire (Bruce B, Fries J F. Health Qual Life Outcomes 2003; 1:20), erythrocyte sedimentation rate (Westergren A. Triangle 1957; 3:20-5), anti-cyclic citrullinated peptide (Nishimura K, et al. Annals of internal medicine 2007; 146:797-808) and rheumatoid factor (Waaler E. “On the occurrence of a factor in human serum activating the specific agglutintion of sheep blood corpuscles.” 1939. Apmis 2007; 115:422-38; discussion 39) (Table 1).

TABLE 1
Demographic Parameters of Participants in the Training and Validation Cohorts

| Group | Control | | OA | | RA | | SLE | |
|---|---|---|---|---|---|---|---|---|
| | Training Cohort | | | | | | | |
| Number | 57 | | 41 | | 53 | | 46 | |
| Age | 42.75 | (10.26) | 60.49 | (13.18) | 56.17 | (14.25) | 44.24 | (14.29) |
| Gender (% F) | 36 | (63%) | 33 | (80%) | 38 | (72%) | 43 | (93%) |
| RF (% +) | 0 | (0%) | 3 | (7%) | 28 | (53%) | 3 | (7%) |
| CRP (% +) | 1 | (2%) | NA | | 21 | (40%) | NA | |
| CCP (% +) | 0 | (0%) | 0 | (0%) | 35 | (66%) | 0 | (0%) |
| Caucasian | 41 | (72%) | 35 | (85%) | 49 | (92%) | 36 | (78%) |
| African American | 5 | (9%) | 1 | (2%) | 3 | (6%) | 4 | (9%) |
| Other | 11 | (19%) | 5 | (12%) | 1 | (2%) | 6 | (13%) |
| | Validation Cohort | | | | | | | |
| Number | 25 | | 23 | | 23 | | 19 | |
| Age | 39.20 | (12.89) | 66.00 | (11.57) | 62.13 | (13.11) | 47.47 | (11.70) |
| Gender (% F) | 16 | (64%) | 18 | (78%) | 17 | (74%) | 17 | (89%) |
| RF (% +) | 0 | (0%) | 3 | (13%) | 8 | (35%) | 1 | (5%) |
| CRP (% +) | 0 | (0%) | NA | | 8 | (36%) | NA | |
| CCP (% +) | 0 | (0%) | 0 | (0%) | 12 | (52%) | 0 | (0%) |
| Caucasian | 17 | (68%) | 20 | (87%) | 21 | (91%) | 12 | (63%) |
| African American | 2 | (8%) | 3 | (13%) | 1 | (4%) | 2 | (11%) |
| Other | 6 | (24%) | 0 | (0%) | 1 | (4%) | 5 | (26%) |

Mean (standard deviation) of ages of participants in each group are shown.
% F = percentage of females;
% + = percentage of positive cases

Gene Expression Profiling

Total RNA was extracted using TRIzol™ Reagent according to the manufacturer's directions (Life Technologies, Carlsbad, Calif.). RNA was then centrifuged through RNeasy mini-columns (Qiagen, Valencia, Calif.) according to the manufacturer's protocol. RNA were quantified spectrophotometrically (Nanodrop ND-1000, Wilmington, Del.) and RNA integrity was assessed using capillary gel electrophoresis (Agilent 2100 Bioanalyzer; Agilent Technologies, Palo Alto, Calif.). Samples used for microarray studies had a mean A₂₆₀:A₂₈₀ ratio of 2.05 and a mean 28s:18s rRNA ratio of 1.61. Biotinylated amplified RNA was produced from 350 ng of total RNA per sample using an Illumina TotalPrep RNA Amplification Kit (Applied Biosystems/Ambion, Austin, Tex.) according to the manufacturer's directions. Amplified RNA was hybridized overnight at 58° C. to WG-6 v3 Expression BeadChips microarrays (Illumina, San Diego, Calif.) which contain 48,803 50-mer oligonucleotide probes with an approximately 20- to 30-fold redundancy in each microarray. Microarrays were washed under high stringency, labeled with streptavidin-Cy3, and scanned using an Illumina BeadStation 500 scanner following the manufacturer's protocols.

Statistical Analysis

A reductionist approach was used, whereby a large number of variables were screened and a parsimonious set of genes were identified. (Kim W J, et al. “A four-gene signature predicts disease progression in muscle invasive bladder cancer” Mol Med 2011; Ling S M, et al. Osteoarthritis Cartilage 2009; 17:43-8; and Knowlton N, et al. Arthritis Rheum 2009; 60:892-900). To identify the genes of interest, a split cohort design was employed where the samples were randomly split 70%/30% into a training and validation cohort. Samples from the training cohort were quantile normalized followed by logarithm base 2 transformation. (Bolstad B M, et al. Bioinformatics 2003; 19:185-93) To allow for a performance evaluation of the model in prospectively collected samples, the quantile normalization procedure was “rooted” by storing the marginal distribution of ranks and means. The stored marginal distribution was used to prospectively normalize any new sample without including information from the new sample into the training cohort, as would happen if the training and validation cohorts were normalized together. The data was then subjected to a modified bootstrapped ANOVA, which under-samples all but the smallest group. This modification of the Bootstrap combines blOck Sampling (Higgins J J. Introduction to Modern Nonparametric Statistics. Pacific Grove, Calif.: Brooks/Cole; 2004) with under-Sampling (Kubat M, Matwin S. Proc. of the Fourteenth International Conference on Machine Learning 1997; Nashville, Tenn.:179-96) and the ANOVA, which is denoted “BOSSANOVA™”. In this case, N samples from each of the patient and control groups were resampled with replacement, where N=min(n1,n2,n3,n4) and n1-4 are the groups. The data were bootstrapped 5000 times. A bootstrap p-value less than 0.05 was considered statistically significant.

In order to be evaluated in multivariate analyses, genes identified above were filtered to include only those with a minimum fold-change between any two groups of 1.75. These genes were then evaluated using several multivariate algorithms including: random forest, boosted trees, K-Nearest Neighbors (K-NN), and Classification and Regression Trees (C&RT). (Breiman L. Machine Learning 2001; 45:5-32; Freund Y, Schapire RE. J. of Computer and System Sciences 1997; 55:119-39; Mico M L, et al. Pattern Recognition Letters 1994; 15:9-17; and Breiman L. Classification and regression trees. Belmont, Calif.: Wadsworth International Group; 1984.) The best performing algorithm was defined as the algorithm with the highest cross-validated classification accuracy. The best performing algorithm was then tested with a reduced number of genes to find the most parsimonious model.

Once the best performing algorithm was identified, the validation cohort was quantile normalized via the marginal distribution of the training set (described above) and logarithm base 2 transformed. The genes identified within the training cohort were extracted and the best multivariate model's algorithm and weights were applied to obtain class predictions. Accuracy, sensitivity and specificity were then determined within the validation cohort.

Normalization and analysis was performed using custom R/Bioconductor scripts. The multivariate analysis was performed in Statistica (StatSoft, Tulsa, Okla.).

BOSSANOVA™ analysis of the microarray data from the training cohort (see Statistical Analysis above), yielded 27 genes that were statistically different and had a fold-change between any two groups greater than 1.75 (Table 2). In Table 2 gene descriptions were obtained from Illumina. The definition for Probe ID ILMN_{—}1818346 was updated from the Unigene database (shown in parentheses). Values listed under each group are normalized signal intensities. Genes highlighed in bold were utilized in final algorithm.

TABLE 2
Genes identified through BOSSANOVA along with their respective mean values

| Gene | | | | | | |
|---|---|---|---|---|---|---|
| Symbol | Definition | Probe ID | Control | OA | RA | SLE |
| MAP2K2 | Mitogen-activated | ILMN_{—}1657968 | 591 | 1073 | 893 | 782 |
| | protein kinase 2 | | | | | |
| KIR2DL3 | Killer cell | ILMN_1667232 | 954 | 680 | 814 | 518 |
| | immunoglobulin-like | | | | | |
| | receptor | | | | | |
| IBRDC3 | IBR domain containing 3 | ILMN_1682081 | 177 | 344 | 274 | 238 |
| ECGF1 | Endothelial cell growth | ILMN_1690939 | 355 | 622 | 502 | 592 |
| | factor 1 | | | | | |
| NCF1 | Neutrophil cytosolic | ILMN_1697309 | 1142 | 2160 | 1659 | 1748 |
| | factor 1 | | | | | |
| CSNK1G2 | Casein kinase 1, | ILMN_{—}1706521 | 2078 | 829 | 1463 | 1348 |
| | gamma 2 | | | | | |
| ADM | Adrenomedullin | ILMN_1708934 | 360 | 530 | 622 | 683 |
| ACTN4 | Actinin, alpha 4 | ILMN_1725534 | 444 | 796 | 645 | 578 |
| DEFA3 | Defensin, alpha 3 | ILMN_1725661 | 172 | 158 | 327 | 304 |
| OAS3 | 2′-5′-oligoadenylate | ILMN_1745397 | 317 | 367 | 337 | 618 |
| | synthetase 3 | | | | | |
| LOC654194 | PREDICTED: Similar | ILMN_{—}1755808 | 6301 | 4006 | 4720 | 8272 |
| | to ribosomal protein | | | | | |
| | S27 | | | | | |
| BSG | Basigin | ILMN_1778374 | 662 | 1395 | 1141 | 1291 |
| LOC346950 | PREDICTED: Similar | ILMN_{—}1786359 | 245 | 392 | 260 | 453 |
| | to ribosomal protein | | | | | |
| | L37 | | | | | |
| ZNF385 | Zinc finger protein 385 | ILMN_1786722 | 177 | 321 | 237 | 268 |
| GRINA | Glutamate receptor, | ILMN_1796490 | 336 | 619 | 440 | 485 |
| | ionotropic, N-methyl D- | | | | | |
| | asparate-associated | | | | | |
| | protein 1 | | | | | |
| — | cDNA FLJ40660 fis, | ILMN_1818346 | 813 | 449 | 496 | 407 |
| | clone THYMU2019686 | | | | | |
| | (predicted DNA-binding | | | | | |
| | protein Ikaros) | | | | | |
| — | cDNA clone | ILMN_1900270 | 546 | 335 | 350 | 310 |
| IFI27 | IMAGE: 2051908 3 | ILMN_2058782 | 89 | 87 | 99 | 334 |
| | Interferon, alpha- | | | | | |
| | inducible protein 27 | | | | | |
| JUNB | Jun B proto-oncogene | ILMN_2086077 | 715 | 1419 | 980 | 1120 |
| LOC653600 | Defensin, alpha 1 | ILMN_2102721 | 168 | 151 | 307 | 309 |
| STXBP2 | Syntaxin binding protein | ILMN_2159453 | 747 | 1686 | 1169 | 1239 |
| | 2 | | | | | |
| LYZ | Lysozyme (renal | ILMN_2162972 | 2139 | 2481 | 2074 | 3730 |
| | amyloidosis) | | | | | |
| DEFA3 | Defensin, alpha 3 | ILMN_2165289 | 186 | 171 | 362 | 347 |
| DEFA1 | Defensin, alpha 1 | ILMN_{—}2193213 | 278 | 254 | 596 | 554 |
| FAM108A2 | Family with sequence | ILMN_2239772 | 436 | 829 | 677 | 629 |
| | similarity 108, member | | | | | |
| | A3 | | | | | |
| ZYX | Zyxin | ILMN_2371169 | 663 | 1251 | 1051 | 977 |
| SPI1 | Spleen focus forming | ILMN_2392043 | 334 | 771 | 528 | 500 |
| | virus proviral integration | | | | | |
| | oncogene (SPI1) | | | | | |

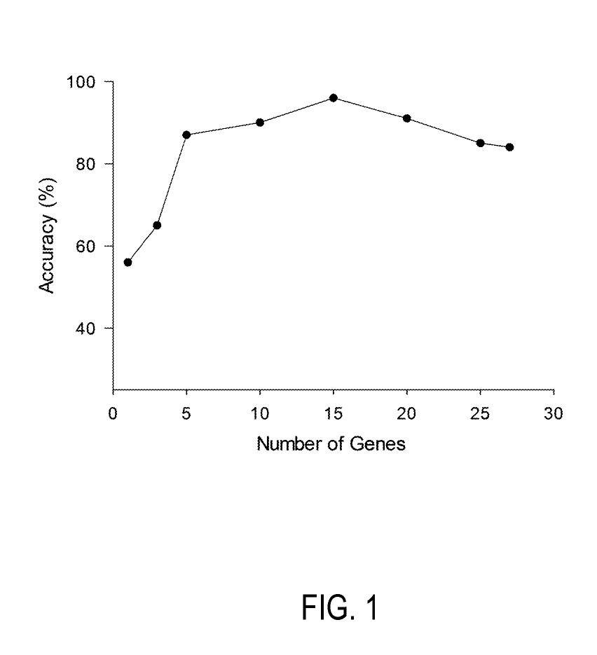

These genes were further analyzed in four different multivariate algorithms. The boosted trees method performed with the highest accuracy in the training data (Table 3). Weights for the model terms obtained from the training data were then applied to the validation data. Random accuracy in a four group dataset is 25%. When the 27 genes in Table 2 were used for group classification, the overall accuracy was 84% in training cohort. In an effort to make the most parsimonious model, the terms were ranked in order of discriminatory accuracy and removed terms to identify the inflection point at which parsimony is achieved. In the dataset, this occurs at 5 terms (FIG. 1). Using these 5 terms resulted in 87% training cohort accuracy and 66% validation cohort accuracy.

TABLE 3
Training Performance of Machine Learning techniques using 27 probes

| | Accuracy |
|---|---|
| Method | (%) |
| Boosted Trees | 84.3 |
| Random | |
| Forest | 77.2 |
| K-NN | 76.1 |
| C&RT | 65.0 |

To confirm how well each individual disease state is classified; specificity and sensitivity were examined across the 4 groups (Table 4). In the training data cohort, the sensitivity was similar among groups, ranging from 85% to 89%. The specificity had a slightly wider range than the sensitivity, with the lowest specificity of 93% in the Control group and the highest specificity in the OA group with 98%. As expected due to independent nature of the validation set, within-group sensitivity in the validation data cohort was lower than in the training data cohort for all groups. The specificity had a much narrower range that the sensitivity in the validation data cohort, where the SLE disease group had an 83% specificity while the OA disease group had 99% specificity.

TABLE 4
Sensitivity and Specificity analysis for the Training and Validation data sets

| | | | | |
|---|---|---|---|---|
| Group | Control | OA | RA | SLE |

Training Data Set Performance

| | | | | |
|---|---|---|---|---|
| Number | 57 | 41 | 53 | 46 |
| Sensitivity | 88% | 88% | 85% | 89% |
| Specificity | 93% | 98% | 97% | 95% |
| | | | Accuracy | 87% |

Validation Data Set Performance

| | | | | |
|---|---|---|---|---|
| Number | 25 | 23 | 23 | 19 |
| Sens | 84% | 52% | 57% | 68% |
| Spec | 86% | 99% | 84% | 83% |
| | | | Accuracy | 66% |

Other genes from the initial set of 27 may be substituted for these with similar results. Such substitutions have been noted by others (Ein-Dor L, et al. Bioinformatics 2005; 21:171-8) and may include results from alternate probes for the same gene or homologous genes. For example, signal intensities from probe ILMN_{—}2193213 were 99% correlated with ILMN_{—}2102721 (another probe for the same gene), and substitution with the latter into the best performing model resulted in an accuracy of 77%. Substitution of data from ILMN_{—}1725661 and ILMN_{—}2165289 (two different probes for defensin A3 that has sequence overlap with DEFA1) resulted in an accuracy of 77% and 76%, respectively. Substitutions may also include probes for other genes. For example, signal intensities from probe ILMN_{—}1657968 (a MAP2K2 probe) were highly correlated with ILMN_{—}1778374 (a probe for the basigin gene, BSG, r=0.81) and ILMN_{—}2239772 (a probe for the abhydrolase domain-containing protein FAM108A2, r=0.86). See Table 5 appended at end of specification. Substitutions with these alternative genes resulted in model performance of 76% and 82% accuracy, respectively.

Additional validation for the 27-marker model using data is provided in Tables 6 and 7:

TABLE 6
Validation Dataset

| | Validation Cohort | | | | | | | |
|---|---|---|---|---|---|---|---|---|
| Group | Control | | OA | | RA | | SLE | |
| Number | 34 | | 42 | | 42 | | 31 | |
| Age | 43.53 | (11.55) | 62.24 | (13.14) | 62.76 | (11.90) | 47.44 | (13.35) |
| Gender (% F) | 26 | (77%) | 30 | (71%) | 30 | (71%) | 28 | (90%) |
| RF (% +) | 0 | (0%) | 4 | (10%) | 33 | (79%) | 3 | (10%) |
| CRP (% +) | 0 | (0%) | X | | 21 | (50%) | X | |
| CCP (% +) | 0 | (0%) | 3 | (7%) | 38 | (91%) | 0 | (0%) |
| Caucasian | 28 | (82%) | 38 | (91%) | 36 | (86%) | 21 | (68%) |
| African American | 1 | (3%) | 2 | (5%) | 3 | (7%) | 4 | (13%) |
| Other | 5 | (15%) | 2 | (5%) | 3 | (7%) | 6 | (19%) |

TABLE 7
Performance in Validation

| Group | Control | OA | RA | SLE |
|---|---|---|---|---|
| Count | 34 | 42 | 42 | 31 |
| Sens | 63% | 74% | 71% | 67% |
| Spec | 93% | 85% | 90% | 89% |
| | | | Accuracy | 68% |

TABLE 5
Pearson Correlation Coefficients of Normalized Signal Intensities

| | ILMN_{—} | ILMN_{—} | ILMN_{—} | ILMN_{—} | ILMN_{—} | ILMN_{—} | ILMN_{—} | ILMN_{—} | ILMN_{—} |
|---|---|---|---|---|---|---|---|---|---|
| | 1657968 | 1667232 | 1682081 | 1690939 | 1697309 | 1706521 | 1708934 | 1725534 | 1725661 |
| ILMN_1657968 | | | | | | | | | |
| ILMN_1667232 | −0.14 | | | | | | | | |
| ILMN_1682081 | 0.76 | −0.22 | | | | | | | |
| ILMN_1690939 | 0.72 | −0.20 | 0.75 | | | | | | |
| ILMN_1697309 | 0.63 | −0.23 | 0.63 | 0.68 | | | | | |
| ILMN_1706521 | −0.30 | 0.03 | −0.36 | −0.24 | −0.26 | | | | |
| ILMN_1708934 | 0.10 | −0.17 | 0.20 | 0.29 | 0.28 | −0.09 | | | |
| ILMN_1725534 | 0.80 | −0.10 | [symbol] | 0.61 | 0.46 | −0.38 | 0.09 | | |
| ILMN_1725661 | −0.01 | −0.04 | −0.05 | −0.03 | 0.14 | −0.01 | 0.26 | −0.01 | |
| ILMN_1745397 | 0.10 | −0.21 | 0.23 | 0.49 | 0.22 | −0.12 | 0.25 | 0.14 | −0.10 |
| ILMN_1755808 | −0.38 | −0.18 | −0.35 | −0.33 | −0.36 | 0.25 | −0.11 | −0.17 | 0.08 |
| ILMN_1778374 | [symbol] | −0.24 | 0.75 | 0.69 | 0.62 | −0.35 | 0.19 | 0.78 | 0.10 |
| ILMN_1786359 | −0.05 | −0.30 | 0.10 | −0.03 | −0.02 | −0.07 | 0.09 | 0.18 | −0.01 |
| ILMN_1786722 | 0.59 | −0.25 | 0.74 | 0.63 | 0.45 | −0.30 | 0.26 | 0.77 | −0.01 |
| ILMN_1796490 | 0.72 | −0.27 | 0.74 | 0.67 | 0.54 | −0.26 | 0.28 | 0.77 | 0.01 |
| ILMN_1818346 | −0.34 | 0.16 | −0.48 | −0.45 | −0.38 | 0.19 | −0.42 | −0.38 | −0.12 |
| ILMN_1900270 | −0.32 | 0.16 | −0.51 | −0.51 | −0.47 | 0.20 | −0.46 | −0.37 | −0.11 |
| ILMN_2058782 | 0.06 | −0.10 | 0.04 | 0.37 | 0.10 | −0.12 | 0.22 | 0.01 | 0.02 |
| ILMN_2086077 | 0.66 | −0.21 | 0.71 | 0.63 | 0.47 | −0.30 | 0.29 | 0.60 | −0.04 |
| ILMN_2102721 | −0.02 | −0.04 | −0.06 | −0.03 | 0.14 | −0.02 | 0.25 | −0.02 | [symbol] |
| ILMN_2159453 | 0.79 | −0.25 | [symbol] | 0.70 | 0.62 | −0.35 | 0.18 | [symbol] | 0.02 |
| ILMN_2162972 | −0.03 | 0.01 | −0.10 | 0.10 | 0.10 | −0.08 | 0.23 | −0.18 | 0.04 |
| ILMN_2165289 | 0.00 | −0.04 | −0.05 | −0.02 | 0.15 | −0.03 | 0.25 | −0.01 | [symbol] |
| ILMN_2193213 | 0.01 | −0.03 | −0.04 | −0.02 | 0.16 | −0.04 | 0.23 | 0.00 | [symbol] |
| ILMN_2239772 | [symbol] | −0.06 | 0.72 | 0.67 | 0.67 | −0.29 | −0.01 | 0.69 | 0.00 |
| ILMN_2371169 | 0.74 | −0.19 | [symbol] | 0.71 | 0.52 | −0.31 | 0.28 | [symbol] | 0.07 |
| ILMN_2392043 | 0.71 | −0.25 | [symbol] | 0.69 | 0.56 | −0.26 | 0.25 | [symbol] | 0.00 |
| | ILMN_{—} | ILMN_{—} | ILMN_{—} | ILMN_{—} | ILMN_{—} | ILMN_{—} | ILMN_{—} | ILMN_{—} | ILMN_{—} |
| | 1745397 | 1755808 | 1778374 | 1786359 | 1786722 | 1796490 | 1818346 | 1900270 | 2058782 |
| ILMN_1657968 | | | | | | | | | |
| ILMN_1667232 | | | | | | | | | |
| ILMN_1682081 | | | | | | | | | |
| ILMN_1690939 | | | | | | | | | |
| ILMN_1697309 | | | | | | | | | |
| ILMN_1706521 | | | | | | | | | |
| ILMN_1708934 | | | | | | | | | |
| ILMN_1725534 | | | | | | | | | |
| ILMN_1725661 | | | | | | | | | |
| ILMN_1745397 | | | | | | | | | |
| ILMN_1755808 | −0.04 | | | | | | | | |
| ILMN_1778374 | 0.21 | −0.14 | | | | | | | |
| ILMN_1786359 | 0.15 | 0.64 | 0.15 | | | | | | |
| ILMN_1786722 | 0.33 | −0.06 | 0.71 | 0.40 | | | | | |
| ILMN_1796490 | 0.25 | −0.08 | [symbol] | 0.32 | [symbol] | | | | |
| ILMN_1818346 | −0.39 | −0.05 | −0.47 | −0.44 | −0.61 | −0.49 | | | |
| ILMN_1900270 | −0.39 | 0.07 | −0.46 | −0.35 | −0.59 | −0.48 | [symbol] | | |
| ILMN_2058782 | 0.75 | −0.04 | 0.18 | −0.05 | 0.03 | 0.04 | −0.22 | −0.22 | |
| ILMN_2086077 | 0.15 | −0.20 | 0.64 | 0.02 | 0.56 | 0.64 | −0.40 | −0.43 | 0.10 |
| ILMN_2102721 | −0.09 | 0.09 | 0.09 | −0.02 | −0.02 | 0.00 | −0.11 | −0.11 | 0.04 |
| ILMN_2159453 | 0.21 | −0.13 | [symbol] | 0.29 | [symbol] | [symbol] | −0.48 | −0.49 | 0.01 |
| ILMN_2162972 | 0.14 | 0.11 | 0.00 | 0.24 | 0.06 | −0.02 | −0.30 | −0.24 | 0.18 |
| ILMN_2165289 | −0.09 | 0.07 | 0.10 | −0.03 | −0.01 | 0.01 | −0.11 | −0.11 | 0.04 |
| ILMN_2193213 | −0.07 | 0.04 | 0.11 | −0.05 | −0.01 | 0.00 | −0.12 | −0.11 | 0.05 |
| ILMN_2239772 | 0.07 | −0.35 | 0.73 | −0.05 | 0.42 | 0.50 | −0.34 | −0.34 | 0.08 |
| ILMN_2371169 | 0.22 | −0.26 | 0.79 | 0.16 | [symbol] | [symbol] | −0.48 | −0.52 | 0.07 |
| ILMN_2392043 | 0.17 | −0.13 | 0.79 | 0.29 | [symbol] | [symbol] | −0.48 | −0.52 | −0.03 |

| | ILMN_{—} | ILMN_{—} | ILMN_{—} | ILMN_{—} | ILMN_{—} | ILMN_{—} | ILMN_{—} | ILMN_{—} |
|---|---|---|---|---|---|---|---|---|
| | 2086077 | 2102721 | 2159453 | 2162972 | 2165289 | 2193213 | 2239772 | 2371169 |
| ILMN_1657968 | | | | | | | | |
| ILMN_1667232 | | | | | | | | |
| ILMN_1682081 | | | | | | | | |
| ILMN_1690939 | | | | | | | | |
| ILMN_1697309 | | | | | | | | |
| ILMN_1706521 | | | | | | | | |
| ILMN_1708934 | | | | | | | | |
| ILMN_1725534 | | | | | | | | |
| ILMN_1725661 | | | | | | | | |
| ILMN_1745397 | | | | | | | | |
| ILMN_1755808 | | | | | | | | |
| ILMN_1778374 | | | | | | | | |
| ILMN_1786359 | | | | | | | | |
| ILMN_1786722 | | | | | | | | |
| ILMN_1796490 | | | | | | | | |
| ILMN_1818346 | | | | | | | | |
| ILMN_1900270 | | | | | | | | |
| ILMN_2058782 | | | | | | | | |
| ILMN_2086077 | | | | | | | | |
| ILMN_2102721 | −0.04 | | | | | | | |
| ILMN_2159453 | 0.65 | 0.01 | | | | | | |
| ILMN_2162972 | −0.02 | 0.05 | 0.06 | | | | | |
| ILMN_2165289 | −0.03 | [symbol] | 0.02 | 0.05 | | | | |
| ILMN_2193213 | −0.03 | [symbol] | 0.02 | 0.05 | [symbol] | | | |
| ILMN_2239772 | 0.58 | −0.01 | 0.69 | 0.00 | 0.01 | 0.03 | | |
| ILMN_2371169 | 0.64 | 0.06 | [symbol] | −0.03 | 0.07 | 0.08 | 0.59 | |
| ILMN_2392043 | 0.63 | −0.02 | [symbol] | −0.07 | −0.01 | −0.01 | 0.61 | [symbol] |

Column and row headings list Illumina Probe ID numbers. Correlation coefficients > 0.8 are shown in bold italics font.

The invention claimed is:

1. A method executed on a computer comprising a processor for scoring a sample, said method comprising:
receiving a dataset associated with a peripheral blood mononuclear cell sample from a subject comprising quantitative data for at least 10 of the biomarkers listed in Table 2; and
determining, by a processor, a score using the quantitative data wherein said score is predictive of diagnosis of rheumatoid arthritis.

2. The method of claim 1 wherein said dataset is obtained by a method comprising:
obtaining said first sample from said first subject, wherein said sample comprises a plurality of analytes;
contacting said first sample with a reagent;
generating a plurality of complexes between said reagent and said plurality of analytes; and
detecting said plurality of complexes to obtain said first dataset associated with said first sample, wherein said first dataset comprises quantitative data for said biomarkers.

3. The method of claim 1 wherein said dataset comprises quantitative data for MAP2K2, CSNK1G2, LOC654194, LOC346950 and DEFA1.

4. The method of claim 1 wherein said determining a score comprises using an interpretation function based on a predictive model.

5. A computer-implemented system, comprising a processor for executing program code; and a non-transitory computer-readable storage medium storing program code executable to perform steps comprising:
receiving a dataset associated with a peripheral blood mononuclear cell sample from a subject comprising quantitative data for at least 10 of the biomarkers listed in Table 2 and
determining, by a processor, a score using the quantitative data wherein said score is predictive of diagnosis of rheumatoid arthritis.

6. The system of claim 5 wherein said dataset is obtained by a method comprising:
obtaining said first sample from said first subject, wherein said sample comprises a plurality of analytes;
contacting said first sample with a reagent;
generating a plurality of complexes between said reagent and said plurality of analytes; and
detecting said plurality of complexes to obtain said first dataset associated with said first sample, wherein said first dataset comprises quantitative data for said biomarkers.

7. The system of claim 5 wherein said dataset comprises quantitative data for MAP2K2, CSNK1G2, LOC654194, LOC346950 and DEFA1.

8. The system of claim 5 wherein said determining a score comprises using an interpretation function based on a predictive model.

9. A non-transitory computer-readable storage medium containing program code, comprising program code for:
receiving a dataset associated with a peripheral blood mononuclear cell sample from a subject comprising quantitative data for at least 10 of the biomarkers listed in Table 2; and
determining a score using the quantitative data wherein said score is predictive of diagnosis of rheumatoid arthritis.

10. The computer-readable storage medium of claim 9 wherein said dataset is obtained by a method comprising:
obtaining said first sample from said first subject, wherein said sample comprises a plurality of analytes;
contacting said first sample with a reagent;
generating a plurality of complexes between said reagent and said plurality of analytes; and
detecting said plurality of complexes to obtain said first dataset associated with said first sample, wherein said first dataset comprises quantitative data for said biomarkers.

11. The computer-readable storage medium of claim 9 wherein said dataset comprises quantitative data for MAP2K2, CSNK1G2, LOC654194, LOC346950 and DEFA1.

12. The computer-readable storage medium of claim 9 wherein said determining a score comprises using an interpretation function based on a predictive model.
